(19) United States
(12) Patent Application Publication
(10) Pub. No.: US 2011/0240651 A1
(43) Pub. Date: Oct. 6, 2011

(54) RECEPTACLE AND WASTE BAG

(76) Inventor: Michael John Gordon, Farnham Royal Buckinghamshire (GB)

(21) Appl. No.: 13/133,860

(22) PCT Filed: Oct. 6, 2009
(86) PCT No.: PCT/GB09/51323

§ 371 Date: Jun. 9, 2011

(30) Foreign Application Priority Data
Oct. 8, 2008 (GB) 0818394.9

(51) Int. Cl. B65F 1/06

(52) U.S. Cl. 220/495.08

(57) ABSTRACT

The present invention relates to a receptacle (1) and a waste bag (10) with a mouth (11) therein. Receptacle (1) has a housing (2) having an open face (4), and support means (3, 12) to support the bag mouth (11) adjacent the housing open face (4). A housing projection (6) is adapted to move from a first position way from a bag in the housing to a second position where the projection deforms a bag in the housing below the bag mouth whereby the bag has a reduced waist portion. In use with the projection (6) in the second position the projection helps to prevent the contents in the bottom of the bag being accessed, and the projection (6) is moved to the first position when the bag is removed from the receptacle (1).

The present invention relates to a receptacle and a waste bag.

Various types of receptacles are known, such as dustbins and the like, which have the perimeter of an upper wall defining an open upper face and supporting a waste bag. Waste is disposed of into the bag which is supported by the receptacle. When the bag is full it is removed and replaced with a new empty bag.

A problem with such receptacles is that the contents of the bag remains exposed, especially if there is no lid to the receptacle. Also when a person holding new waste material places there hand into the bag to deposit the waste, the hand can become contaminated with the waste. This can be dangerous if the waste is of a hazardous nature, e.g. hospital or chemical waste. Also, it is important in such situations that the bag be only removable by those with permission to do so, not by children or non authorised persons. Also when the bag is full, it can be difficult to seal the mouth of the bag, e.g. with a closure device.

The invention seeks to provide a solution to this problem.

According to the present invention there is provided a receptacle and a waste bag with a mouth therein comprising:

a) a receptacle housing having an open face,
b) support means to support the bag mouth adjacent the housing open face, and
c) a housing projection adapted to move from a first position way from a bag in the housing to a second position where the projection deforms a bag in the housing below the bag mouth whereby the bag has a reduced waist portion,
in use with the projection in the second position the projection helping to prevent the contents in the bottom of the bag being accessed, and said projection being moved to the first position when the bag is removed from the receptacle.

Preferably the projection forms a downwardly inclined surface whereby the reduced waist portion forms an inclined chute to deliver waste towards the bottom of the bag.

Preferably the projection is mounted on a flap hinged the housing wall which moves from a first open position with the projection in the first position, and moves to a second closed position with the projection in the second position.

In one embodiment the receptacle housing further comprises a second fixed projection opposing the projection whereby the projection and second fixed projection causing the bag to have a reduced waist portion. Preferably the second fixed projection is below the projection whereby to cause the reduced waist portion to have a “z-bend”.

An embodiment of the invention will now be described with reference to the accompanying drawings in which:

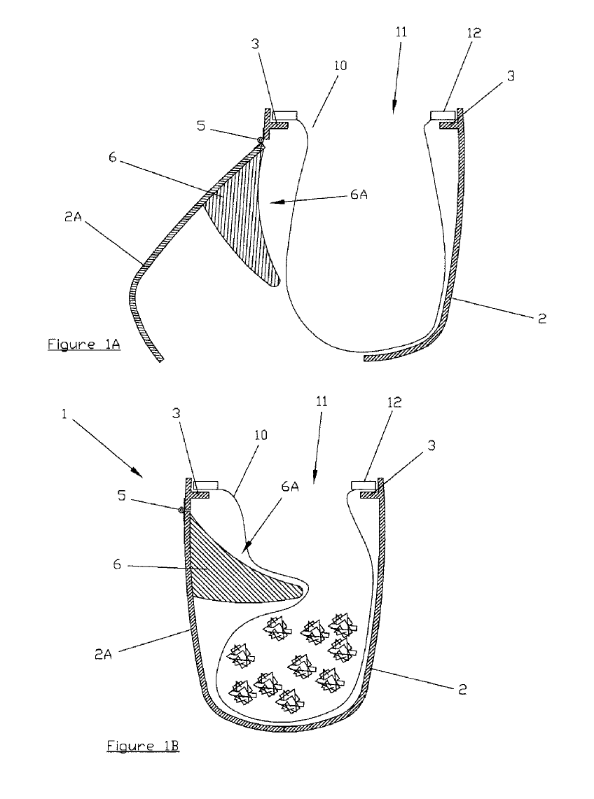

FIG. 1A shows a cross section view with the projection in the first position,

FIG. 1B shows a cross section view with the projection in the second position,

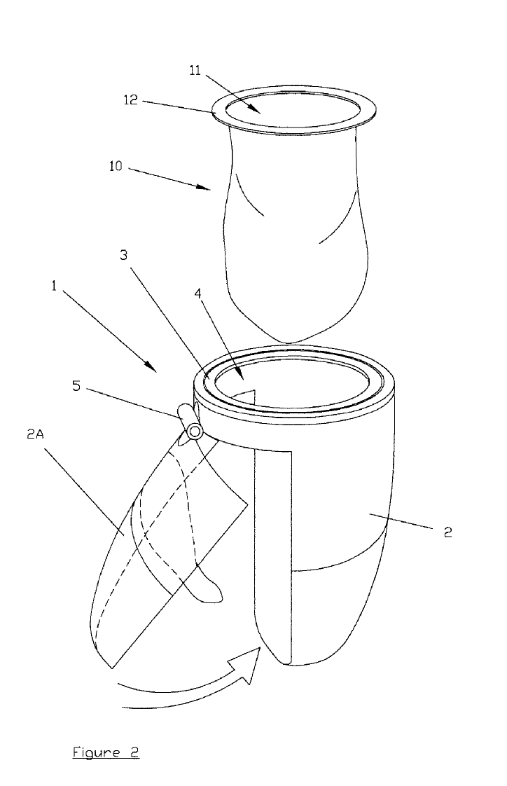

FIG. 2 shows a perspective view of a receptacle and bag, and

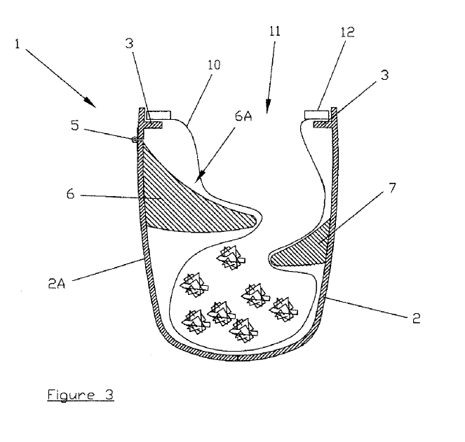

FIG. 3 shows a cross section view of an alternative construction with a second fixed projection.

Referring to the drawings there is shown a receptacle 1 and a waste bag 10 with a mouth 11.

Receptacle 1 has half ellipsoidal housing 2. An inwardly directed recessed flange 3 extends around the open end of the housing to define a circular open face 4. A segment of housing 2 forms a flap 2A hinged to housing 2 by hinge 5. Secured to the inside of flap 2A is a housing projection 6 with a downwardly inclined surface 6A. Flap 2A can move from a first open position with the projection in a first position (see FIG. 1A) to a second closed position with the projection in a second position (see FIG. 2B).

Waste bag 10 has an annular disc 12 forming the bag mouth which sits on the recessed flange 3. Disc 12 and flange 3 provide a support means to support the bag mouth adjacent the housing open face 4.

When flap 2A and projection 6 is in the first position, the bag can be removed from or inserted into the receptacle 1. When flap 2A with projection 6 is moved to the second position (see FIG. 1B), the projection 6 deforms the bag in the housing below the bag mouth whereby the bag has a reduced waist portion helping to prevent the contents in the bottom of the bag being accessed. When in the second position, downwardly inclined surface 6A also forms an inclined chute to deliver waste towards the bottom of the bag.

When the waste bag is full, flap 2A and projection 6 is lifted back to the first position. The bag has no longer a reduced waist and returns to full volume making refuse in the bag fall still further into the bottom of the bag. If the mouth of the bag has a closure (e.g. if disc 12 forms a closure) to seal the mouth, the action of closing the bag mouth is easier when refuse is in the bottom of the bag.

It will be appreciated that the housing projection 6 acts as a sort of security device when the bag 10 contains spent wipes. The bloated bag cannot actually be removed past the projection (see FIG. 1B where the mass of spent wipes may be larger than the gap between the projection and the wall of the housing), and the chamber thus needs to be opened before the bag can be removed.

Referring now to FIG. 3 there is shown an alternative embodiment similar to that shown in FIGS. 1B except that an additional second fixed projection 7 is provided. Second fixed projection 7 opposes the projection 6 whereby the projection 6 and second fixed projection 7 both cause the bag to have a reduced waist portion. The second fixed projection 7 is below the projection 6 whereby to cause the reduced waist portion to have a “z-bend”. This “z-bend” further restricts the access to used wipes compared to the construction shown in FIG. 1B.

It is envisaged that the receptacle described above may form part of a dispenser of wipes as disclosed in co-pending patent application #GB0617066.6, GB0612262.6, the contents of which are hereby incorporated herein by reference. The bag described above may be of the type disclosed in co-pending patent application #GB0710596.8, the contents of which are hereby incorporated herein by reference, and the disc 12 may form the mouth member described in that application.

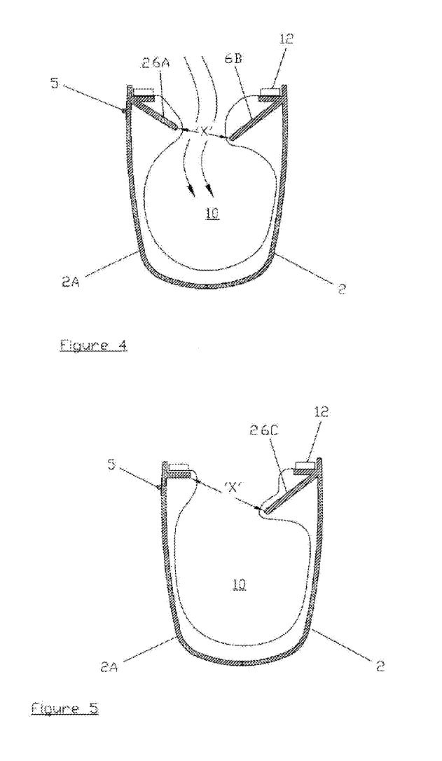

The invention may take a form different to that specifically described above. In particular, referring to FIG. 4, the first indent 26A and second indent 26B are both mounted to the fixed housing 2, with no indent on the door 5. Referring to FIG. 5, in an even simpler deisgn, only a single indent 26C mounted to the fixed housing is provided to inhibit access to the bag 10 via the mouth 11.

Further modifications will be apparent to those skilled in the art without departing from the scope of the present invention.

1. A receptacle and a waste bag with a mouth therein comprising:
a) a receptacle housing having an open face,
b) support means to support the bag mouth adjacent the housing open face, and
c) at least one housing projection adjacent the open face extending into the housing where the or each projection deforms a bag in the housing below the bag mouth whereby the bag has a reduced waist portion, the reduced waist portion remaining sufficiently open that waste collects in the lower regions of the bag below the reduced waist portion,
in use the or each projection helping to prevent the contents in the bottom of the bag being accessed.

2. A receptacle and a waste bag according to claim 1, wherein there is provided a housing projection adapted to move from a first position way from a bag in the housing to a second position where the projection deforms a bag in the housing below the bag mouth whereby the bag has a reduced waist portion, in use with the projection in the second position the projection helping to prevent the contents in the bottom of the bag being accessed, and said projection being moved to the first position when the bag is removed from the receptacle.

3. A receptacle and a waste bag according to claim 1, wherein the projection forms a downwardly inclined surface whereby the reduced waist portion forms an inclined chute to deliver waste towards the bottom of the bag.

4. A receptacle and a waste bag according to claim 3 wherein the projection is mounted on a flap hinged the housing wall which moves from a first open position with the projection in the first position, and moves to a second closed position with the projection in the second position.

5. A receptacle and a waste hag according to claim 4, further comprising a second fixed projection opposing the projection whereby the projection and second fixed projection causing the bag to have a reduced waist portion.

6. A receptacle and a waste bag according to claim 5, wherein the second fixed projection is below the projection whereby to cause the reduced waist portion to have a “z-bend”.

7. (canceled)

8. A receptacle and a waste hag according to claim 1, wherein the projection forms a downwardly inclined surface whereby the reduced waist portion forms an inclined chute to deliver waste towards the bottom of the bag.

9. A receptacle and a waste bag according to claim 8, wherein the projection is mounted on a flap hinged the housing wall which moves from a first open position with the projection in the first position, and moves to a second closed position with the projection in the second position.

10. A receptacle and a waste bag according to claim 9, further comprising a second fixed projection opposing the projection whereby the projection and second fixed projection causing the bag to have a reduced waist portion.

11. A receptacle and a waste bag according to claim 11, wherein the second fixed projection is below the projection whereby to cause the reduced waist portion to have a “z-bend”.

12. A receptacle and a waste bag according to claim 2, wherein the projection is mounted on a flap hinged the housing wall which moves from a first open position with the projection in the first position, and moves to a second closed position with the projection in the second position.

13. A receptacle and a waste bag according to claim 12, further comprising a second fixed projection opposing the projection whereby the projection and second fixed projection causing the hag to have a reduced waist portion.

14. A receptacle and a waste hag according to claim 13, wherein the second fixed projection is below the projection whereby to cause the reduced waist portion to have a “z-bend”.

15. A receptacle and a waste bag according to claim 2, further comprising a second fixed projection opposing the projection whereby the projection and second fixed projection causing the bag to have a reduced waist portion.

16. A receptacle and a waste hag according to claim 15, wherein the second fixed projection is below the projection whereby to cause the reduced waist portion to have a “z-bend”.

17. A receptacle and a waste hag according to claim 2, wherein the second fixed projection is below the projection whereby to cause the reduced waist portion to have a “z-bend”.

18. A receptacle and a waste hag according to claim 1, wherein the projection is mounted on a flap hinged the housing wall which moves from a first open position with the projection in the first position, and moves to a second closed position with the projection in the second position.

19. A receptacle and a waste bag according to claim 18, further comprising a second fixed projection opposing the projection whereby the projection and second fixed projection causing the bag to have a reduced waist portion.

20. A receptacle and a waste bag according to claim 1, further comprising a second fixed projection opposing the projection whereby the projection and second fixed projection causing the bag to have a reduced waist portion.

21. A receptacle and a waste bag according to claim 1, wherein the second fixed projection is below the projection whereby to cause the reduced waist portion to have a “z-bend”.
